(19) United States
(12) Patent Application Publication
(10) Pub. No.: US 2025/0133039 A1
(43) Pub. Date: Apr. 24, 2025

(54) METHOD, COMPUTER DEVICE, AND NON-TRANSITORY COMPUTER-READABLE RECORD MEDIUM TO GENERATE AND DISPLAY CHATROOM MESSAGE SUMMARY

(71) Applicant: LINE Plus Corporation, Seongnam-si (KR)

(72) Inventors: Soon Hyun KWON, Seongnam-si (KR); Daeun JUNG, Seongnam-si (KR); Changkeun CHON, Seongnam-si (KR); Hoyoung CHO, Seongnam-si (KR); Hyojin KWON, Seongnam-si (KR); Seung Hwan LEE, Seongnam-si (KR); Hyeyoung KWON, Seongnam-si (KR); Bumsuk LEE, Seongnam-si (KR); Chan Hyeong LEE, Seongnam-si (KR); Bokyung KANG, Seongnam-si (KR); Seo Jeong CHOI, Seongnam-si (KR); Hyun Young KIM, Seongnam-si (KR); Sowon KIM, Seongnam-si (KR); Su Hyeon NA, Seongnam-si (KR)

(73) Assignee: LINE Plus Corporation, Seongnam-si (KR)

(21) Appl. No.: 18/924,444

(22) Filed: Oct. 23, 2024

(30) Foreign Application Priority Data
Oct. 24, 2023 (KR) 10-2023-0142953

(51) Int. Cl. H04L 51/04; H04L 51/216

(52) U.S. Cl. CPC H04L 51/04; H04L 51/216

(57) ABSTRACT

A method of generating and displaying a chatroom message summary may include generating a message summary using at least one message included in a corresponding chatroom for each chatroom; and displaying the message summary through a different interface depending on a message read status of a user that requests entry into the chatroom.

### CROSS-REFERENCE TO RELATED APPLICATION(S)

This U.S. non-provisional application and claims the benefit of priority under 35 U.S.C. § 119 to Korean Patent Application No. 10-2023-0142953, filed Oct. 24, 2023, the entire contents of which are incorporated herein by reference in their entirety.

### BACKGROUND

### Technical Field

Some example embodiments relate to technology for providing chatroom message summary.

### Related Art

An instant messenger that is a general communication tool refers to software that allows a user to send and receive a message or data in real time and allows the user to register a contact on a messenger and to send and receive messages with a counterpart on a contact list in real time.

Due to such a messenger function, this messenger function is commonly used in a mobile environment of a mobile communication terminal as well as a personal computer (PC).

For example, a mobile messenger service system and mobile communication terminals may utilize a wireless communication network to provide a messenger service between mobile messengers installed on the mobile communication terminals.

As the use of an instant messenger becomes more popular and functions provided through the instant messenger become more diversified. In particular, as importance of personal information protection is emphasized, an openchat function that enables a chat using a link without sharing personal information, such as a telephone number and an ID, is being serviced.

### SUMMARY

Some example embodiments may generate a message summary for each chatroom for chatrooms that meet a condition among chatrooms.

Some example embodiments may determine a cycle based on characteristics of a chatroom and may generate a message summary every determined cycle.

Some example embodiments may target a user that meets a condition among users participating in a chatroom and may display a message summary through a user interface (UI) distinguished from other users.

At least some example embodiments relate to a message summary providing method executed by a computer device including at least one processor configured to execute computer-readable instructions included in a memory.

In some example embodiments, the message summary providing method includes generating, by the at least one processor, a message summary using at least one message included in a corresponding chatroom for each chatroom; and displaying, by the at least one processor, the message summary through a different interface depending on a message read status of a user that requests entry into the chatroom.

According to some example embodiments, the message summary providing method may include determining a message summary generation status according to a condition related to a message of the chatroom for each chatroom.

According to some example embodiments, the determining the message summary generation status may include determining the chatroom as a chatroom subject to summary when a number of messages exchanged through the chatroom after a previous message summary is greater than or equal to a threshold.

According to some example embodiments, the determining the message summary generation status may include setting a cycle or a time for determining the condition and the message summary generation status based on traffic analysis results of the chatroom for each chatroom.

According to some example embodiments, the generating the message summary may include selecting messages exchanged through the chatroom after a previous message summary as messages subject to summary.

According to some example embodiments, the generating the message summary may include selecting a message corresponding to a text type among messages exchanged through the chatroom after a previous message summary as a message subject to summary.

According to some example embodiments, the generating the message summary may include modifying an order of the messages subject to summary based on relationships between the messages.

According to some example embodiments, the generating the message summary may further include generating the message summary based on meta information associated with the chatroom with the messages subject to summary, and the meta information may include at least one of a title, a description, a topic, and a category of the chatroom.

According to some example embodiments, the displaying the message summary may include classifying the user as a target user or a general user based on a condition associated with at least one of a number of unread messages or a last visit time in the chatroom.

According to some example embodiments, the displaying the message summary may further include highlighting and displaying the message summary for the target user through an interface different from that of the general user.

According to some example embodiments, the displaying the message summary may include generating summary content that summarizes at least one message included in the chatroom and a main keyword that represents the summary content.

According to some example embodiments, the message summary providing method may further include generating, by the at least one processor, recommendation content related to the message summary for the message summary.

According to some example embodiments, the message summary providing method may further include generating, by the at least one processor, at least one of the message summary or recommendation content related to the message summary for the chatroom as content that introduces the chatroom.

According to some example embodiments, the message summary providing method may further include providing, by the at least one processor, a message summary that matches the user's tag of interest among message summaries generated based on the chatroom as the user's personal recommendation feed.

At least some example embodiments relate to a non-transitory computer-readable record medium storing instructions that, when executed by a processor, cause the processor to execute the message summary providing method of claim 1 on the computer device.

At least some example embodiments relate to a computer device including at least one processor configured to execute computer-readable instructions included in a memory to configure the computer device to generate a message summary using at least one message included in a corresponding chatroom for each chatroom; and display the message summary through a different interface depending on a message read status of a user that requests entry into the chatroom.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method performed by a computer device according to at least one example embodiment;

FIG. 4 illustrates an example of a process of determining a message summary generation status of a chatroom according to at least one example embodiment;

FIG. 5 illustrates an example of a message summary generation process according to at least one example embodiment;

FIG. 6 illustrates an example of a message summary providing process according to at least one example embodiment; and

FIGS. 7 to 10 illustrate examples of providing and using a message summary according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

Some example embodiments relate to technology for providing a chatroom message summary.

At least some example embodiments are directed to a method, computer device and non-transitory computer-readable record medium that generates a message summary for each chatroom that meets a condition rather than for the entire chatrooms and then emphasizes and displays the message summary for some target users among users in a corresponding chatroom through a user interface (UI) different from other users.

A message summary providing system according to some example embodiments may be implemented by at least one computer device. A message summary providing method according to some example embodiments may be performed by at least one computer device included in the message summary providing system. Here, a computer program according to an example embodiment may be installed and run on the computer device and the computer device may perform the message summary providing method according to example embodiments under control of the computer program. The aforementioned computer program may be stored in a computer-readable record medium to implement the message summary providing method in conjunction with the computer device.

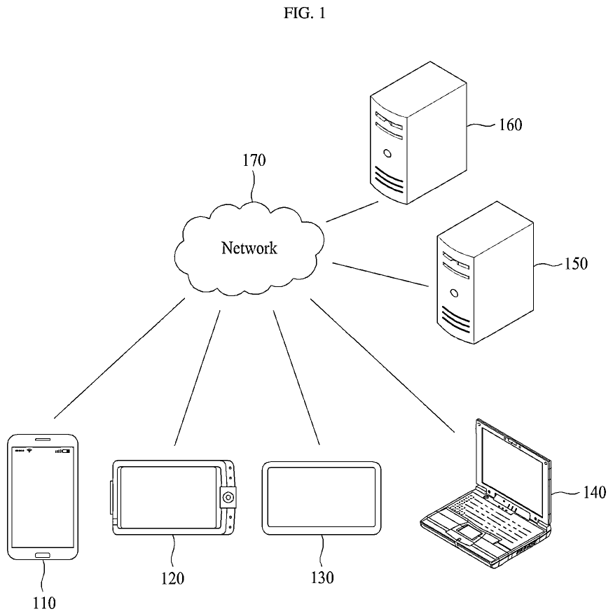

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the at least one example embodiment and an environment applicable to example embodiments of the present disclosure are not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, a messenger service, to the plurality of electronic devices 110, 120, 130, and 140 connected over the network 170.

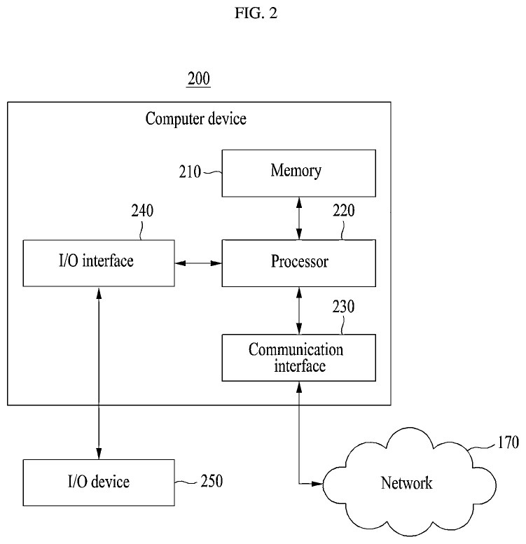

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. Here, the permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files that have been received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the computer device 200 and another apparatus, for example, the aforementioned storage devices over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components of FIG. 2. However, there is no need to clearly illustrate most conventional components. For example, the computer device 200 may be configured to include at least a portion of the I/O device 250 or may further include other components, such as a transceiver and a database.

Hereinafter, some example embodiments of methods and devices for generating and displaying a chatroom message summary are described.

Although the following example embodiments are described using an instant message as a representative example, any social platforms that provide various types of services using resources, such as user profile information and friend relationships in a social network service, as well as the social network service such as a messenger, may be applied in addition to the messenger.

Herein, an openchat refers to a chat service that allows users to have conversations over a topic of interest and also refers to a community service that allows direct chatting through a link such as a uniform resource locator (URL), without a friend addition process using a telephone number or an ID. The openchat may include a function that automatically launches a messenger and runs a chatroom corresponding to a corresponding link to allow an immediate chat in response to clicking the link.

At least some example embodiments may summarize messages included in an openchat chatroom through an artificial intelligence (AI) solution and, here, may display a message summary for a user having accumulated unread messages in the corresponding chatroom.

The following example embodiments describe the openchat as a representative example, but example embodiments are not limited thereto, and may be applied to a one-on-one chatroom according to relationship information and all chatrooms associated with an instant messenger such as a group chatroom and an official account chatroom, in addition to the openchat.

The computer device 200 according to at least some example embodiments may provide a client with a messenger service through connection to an exclusive application installed on the client or a website/mobile site related to the computer device 200. A message summary providing system implemented as a computer may be configured in the computer device 200. For example, the message summary providing system may be implemented in the form of a program that independently operates or may be configured in an in-app form of a specific application to be operable on the specific application.

The processor 220 of the computer device 200 may be implemented as a component to perform the following message summary providing method. Depending on example embodiments, components of the processor 220 may be selectively included in or excluded from the processor 220. Also, depending on example embodiments, the components of the processor 220 may be separated or merged for functional representation of the processor 220.

The processor 220 and the components of the processor 220 may control the computer device 200 to perform operations included in the following message summary providing method. For example, the processor 220 and the components of the processor 220 may be configured to execute an instruction according to a code of at least one program and a code of an OS included in the memory 210.

Here, the components of the processor 220 may be representations of different functions performed by the processor 220 in response to an instruction provided from a program code stored in the computer device 200.

The processor 220 may read a desired instruction from the memory 210 to which instructions related to control of the computer device 200 are loaded. In this case, the read instruction may include an instruction for controlling the processor 220 to perform the following operations.

Operations included in the following message summary providing method may be performed in an order different from illustrated order. Some of the operations may be omitted or an additional process may be further included.

Operations included in the message summary providing method may be performed by the server 150. Depending on example embodiments, at least some of operations may be performed by the client.

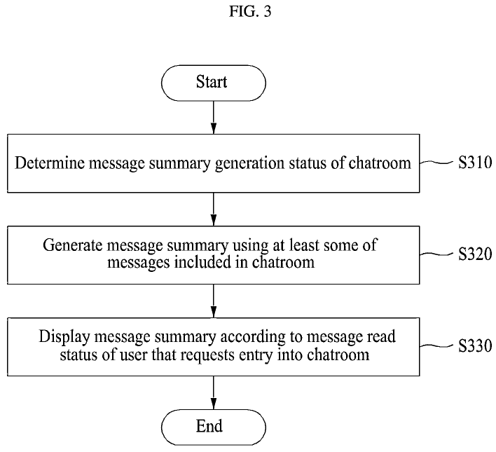

FIG. 3 is a flowchart illustrating an example of a method performed by a computer device according to at least one example embodiment.

Referring to FIG. 3, in operation S310, the processor 220 may determine a message summary generation status for each chatroom using a desired (or, alternatively, a predetermined) message summary generation condition. The processor 220 may determine a chatroom that meets a condition among all chatrooms as a chatroom that requires a message summary.

For example, the message summary generation condition may include a number of messages exchanged through the corresponding chatroom. For example, if the number of messages corresponding to a text type among messages generated in a chatroom from a time of a previous message summary to a current point in time is greater than or equal to a threshold, the processor 220 may determine the corresponding chatroom as a chatroom that requires a message summary, that is, a chatroom subject to summary. As another example, if the number of messages determined to be significant among messages generated in a chatroom from a time of a previous message summary to a current point in time is greater than or equal to threshold, the processor 220 may determine the corresponding chatroom as a chatroom subject to summary. Here, the message summary generation condition may be set as a common fixed condition for all chatrooms. The threshold that is the message summary target condition and a cycle (or time) for determining a message summary generation status, that is, whether to generate a message summary may be applied equally to all chatrooms. For example, the processor 220 may verify the number of messages in all chatrooms every desired (or, alternatively, set) time and may classify a chatroom with the number of messages greater than or equal to the threshold as a chatroom subject to message summary. Depending on example embodiments, the processor 220 may set a threshold that is a message summary target condition and a cycle (or time) for determining a message summary generation status in consideration of the nature of a corresponding chatroom for each chatroom. The processor 220 may analyze message traffic per unit time for each chatroom and may set the threshold that is the message summary target condition and the cycle for determining the message summary generation status based on analysis results. For example, a threshold may be set to be large for a chatroom with a large number of messages generated to make a generation cycle shorter. If a condition determined for a cycle set to a corresponding chatroom for each chatroom is met, the chatroom may be determined as a chatroom that requires a message summary.

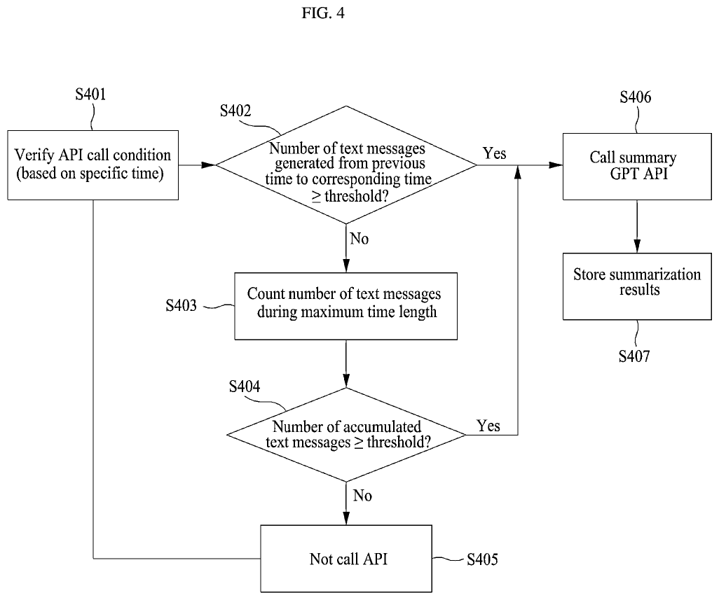

Operation S310 will be discussed in more detail below with reference to FIG. 4.

In operation S320, in the case of a chatroom that meets the message summary generation condition, the processor 220 may generate the message summary using at least some of messages included in the chatroom. The processor 220 may generate the message summary by calling a message summary interface linked with the server 150 and/or the other server 160. For example, the processor 220 may generate a message summary through an artificial intelligence (AI) solution using a language model by calling the language model (e.g., a generative pre-trained transformer (GPT)) API for message summary.

In some example embodiments, the processor 220 may select and summarize messages corresponding to a text type among messages generated in the chatroom from a time of a previous message summary to a current point in time as messages subject to summary. For example, the processor 220 may extract a keyword or a topic for an image or video message for messages corresponding to an image or video type among the messages generated in the chatroom from the time of the previous message summary to the current point in time, and may summarize text message content and the keyword or the topic of the image or video message together. Depending on example embodiments, messages subject to summary may be summarized using meta information of the chatroom. Here, the meta information may include at least one of a title, a description, a topic, and a category of the chatroom.

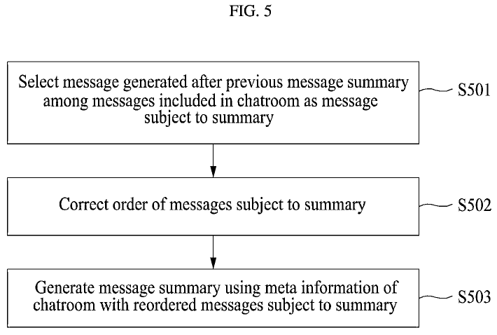

Operation S320 will be discussed in more detail below with reference to FIG. 5.

In operation S330, in response to a request for entry into the chatroom from a user, the processor 220 may display the message summary through a different interface depending on the user's message read status in the chatroom. The processor 220 may classify the user as a target user or a general user depending on the message read status in the chatroom. The message read status is to determine needs for message summary in the chatroom and, for example, may represent the number of unread messages in the chatroom and an amount of time elapsed since a last visit is made in the chatroom. Without displaying the message summary for all users participating in the chatroom through the same user interface, the processor 220 may display the message summary for a target user that meets a condition for the message read status and a general user that does not meet the condition, through different interfaces, respectively. The processor 220 may display the message summary for the target user through a more emphasized user interface that is different from that of the general user.

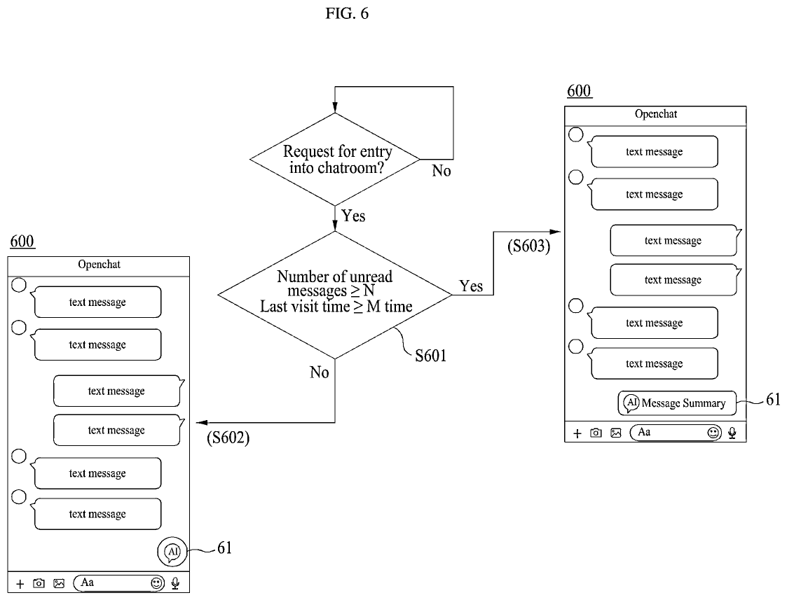

Operation S330 will be discussed in more detail below with reference to FIGS. 6-10.

FIG. 4 illustrates an example of a process of determining a message summary generation status of a chatroom according to at least one example embodiment.

Referring to FIG. 4, in operation S401, the processor 220 may verify an API call condition that indicates a message summary generation condition. The API call condition may indicate a cycle (or time) for determining a message summary generation status, that is, whether to generate a message summary and a threshold that is a message summary target condition, which may be commonly set for all chatrooms or may be differently set for each chatroom.

In operation S402, the processor 220 may determine whether the number of messages corresponding to a text type generated in a corresponding chatroom from a time of a previous message summary to a current point in time according to the API call condition is greater than or equal to the threshold.

When the number of text messages within the chatroom generated after the previous message summary is less than the threshold, the processor 220 may count the number of text messages during a maximum time length in operation S403.

In operation S404, the processor 220 may determine whether the number of text messages counted during the maximum time length is greater than or equal to the threshold that is the message summary target condition.

When the number of text messages counted during the maximum time length is less than the threshold, the processor 220 may determine that the message summary generation condition is not met and may not call a message summary interface in operation S405.

When the number of text messages accumulated in the chatroom from the time of the previous message summary to the current point time is greater than or equal to the threshold, the processor 220 may call a language model API for message summary as a message summary interface and may generate the message summary in operation S406.

In operation S407, the processor 220 may store and manage the message summary generated through the AI solution using the language model in association with the corresponding chatroom.

The aforementioned process (operations S401 to S407) may be repeated for each chatroom every set cycle (or time), and the message summary may be generated for a chatroom that meets the message summary generation condition.

At least some example embodiments may generate, store, and manage a single common message for each chatroom on the server 150, rather than performing the message summary in response to a user request for each individual client.

FIG. 5 illustrates an example of a message summary generation process according to at least one example embodiment.

The processor 220 may generate a message summary for each chatroom that meets a message summary generation condition.

Referring to FIG. 5, in operation S501, the processor 220 may select a message of a text type generated in the chatroom from a time of a previous message summary to a current point in time among messages included in the chatroom as a message subject to summary.

If a previous message summary history is present in the chatroom, the processor 220 may select text messages exchanged through the chatroom after the previous summary message as messages subject to summary.

In operation S502, the processor 220 may correct order of messages subject to summary based on relationships between the messages.

For example, in the case of a message written with a reply or mention function among the messages subject to summary, the processor 220 may modify the message order by changing the corresponding message to a message in the following order after a related message. For example, for message A, when a reply to message A is received after a significant amount of time elapses after sending message A and messages on different topics are sent and received, generating a message summary without correcting the order of message A and the reply message may degrade summarization performance. To improve summarization performance, the reply to message A may be reordered to a message that immediately follows message A.

In operation S503, the processor 220 may generate the message summary using meta information of the chatroom with the reordered messages subject to summary. The meta information may include at least one of a title of the chatroom, description of the chatroom written by at least one of a chatroom administrator and participant, a topic of the chatroom analyzed by the processor 220, and a category of the chatroom analyzed by the processor 220. The processor 220 may reflect meta information of the chatroom as a content boundary for summarizing messages in the corresponding chatroom.

The processor 220 may generate the message summary by summarizing messages subject to summary using a large-scale language model or a document summary model. Here, the large-scale language model may represent a language model that may perform inference without fine-tuning, using a method such as few-shot learning, and may have more than 10 times as many parameters (e.g., 10 billion parameters or more) compared to the existing general language models. For example, large-scale language models, such as GPT-3 and HyperClova, are excellent few-shot learners controllable through a natural text prompt and may perform in-context learning of ability to solve natural language processing (NLP) problems by understanding a pattern with only a small amount of data through a prompt. In addition to a few-shot learning method using a prompt example, a zero-shot learning method controllable through a directive without a prompt example and a fine-tuning-based learning method may be used to summarize messages. A document summarization model may represent a learning model that identifies structural features of a document, structures the document according to a certain rule, and then extracts a frequently occurring pattern from structured paragraphs of the document, and automatically summarizes messages subject to summary with at least one keyword using NLP technology. The processor 220 may use a language-based learning model, such as the large-scale language model and the document summarization model, to generate a message summary in which messages subject to summary in a corresponding chatroom are summarized with at least one keyword for each chatroom.

FIG. 6 illustrates an example of a message summary providing process according to at least one example embodiment.

Referring to FIG. 6, in operation S601, when a request for entry into a chatroom is received from a user, the processor 220 may verify a message read status of the user in the chatroom.

For example, the processor 220 may determine whether the number of unread messages in the chatroom is greater than or equal to a desired (or, alternatively, a predetermined) number (N) as the message read status and whether a certain amount of time (M time) is elapsed after a last visit to the chatroom.

If at least one of a condition that the number of unread messages in the chatroom is greater than or equal to the desired (or, alternatively, the predetermined) number and a condition that the certain amount of time is elapsed after the last visit is not met, the processor 220 may classify the user that requests entry into the chatroom as a general user in operation S602.

When all the condition that the number of unread messages in the chatroom is greater than or equal to the desired (or, alternatively, the predetermined) number and the condition that the certain amount of time is elapsed after the last visit are met, the processor 220 may classify the user that requests entry into the chatroom as a target user in operation S603.

In the case of the general user, the processor 220 may not display a user interface (UI) 61 for accessing a message summary or may display the UI 61 in a default state on a chatroom screen 600 at the time of entering the chatroom screen 600 according to a user entry request.

Meanwhile, in the case of the target user, the processor 220 may highlight and display the UI 61 for accessing the message summary on the chatroom screen 600 at the time of entering the chatroom screen 600.

That is, when entering the chatroom screen 600, the processor 220 may differentiate between the general user and the target user and may differently activate the UI 61 for accessing the message summary on the chatroom screen 600.

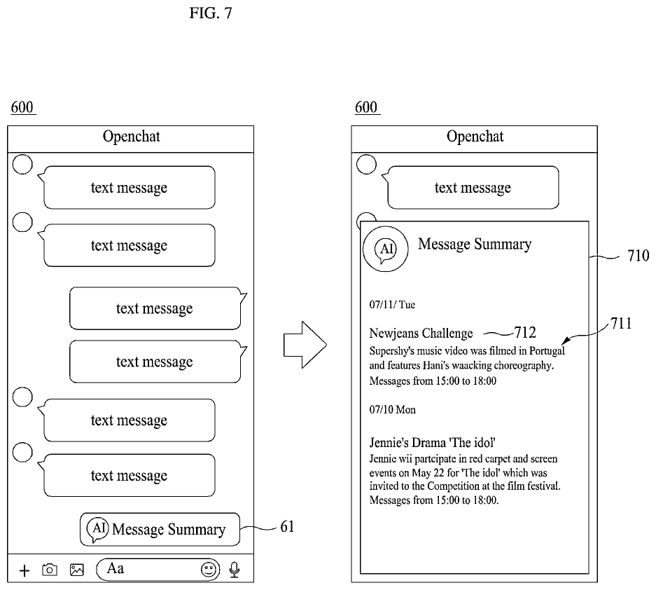

FIGS. 7 to 10 illustrate examples of providing and using a message summary according to at least one example embodiment.

Referring to FIG. 7, when the user enters the chatroom screen 600 and selects the UI 61 for accessing a message summary, the processor 220 may provide a message summary page 710. A message summary in which messages subject to summary are summarized in a simple bullet may be displayed on the message summary page 710 at each cycle, and summary content 711 that summarizes a message subject to summary for each case and a main keyword 712 capable of representing the summary content 711 may be included in the message summary page 710.

The processor 220 may extract the main keyword 712 of the message summary by applying known techniques for extracting a most important word from a document based on importance of the word, such as term frequency-inverse document frequency (TF-IDF) and Text-rank.

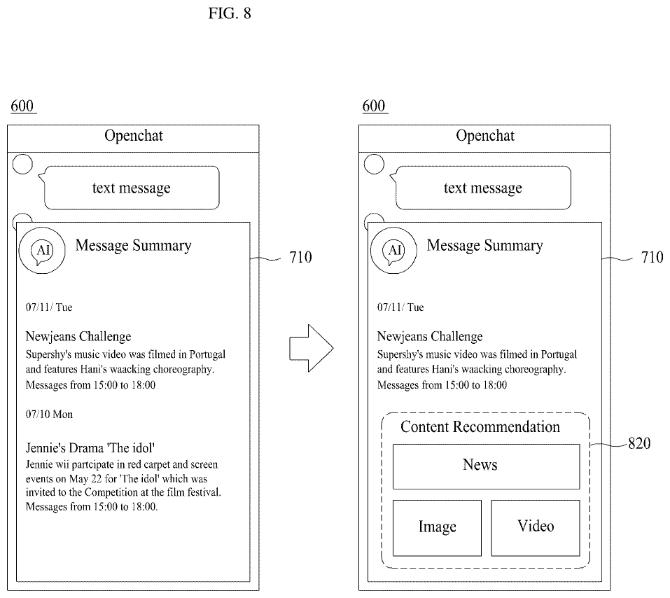

Referring to FIG. 8, when the user selects a message summary in a specific bullet on the message summary page 710, the processor 220 may provide recommendation content 820 related to the corresponding message summary. For example, the processor 220 may retrieve content such as news, video, image, and/or audio, using the main keyword 712 of the selected message summary and may select and display at least one retrieved content as the recommendation content 820 related to the message summary.

In addition to the recommendation content 820 related to the message summary, the processor 220 may provide more expanded content using the message summary based on the chatroom. For example, the processor 220 may generate and provide a message summary in a separate content form by merging at least two message summaries generated every cycle and may find content related to accumulated message summaries and provide the same as another form of recommendation content.

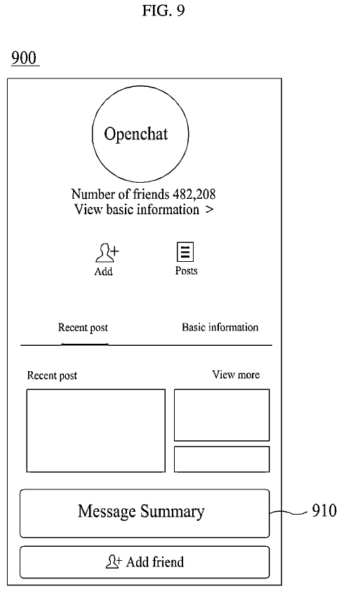

The processor 220 may use a message summary generated every cycle based on a chatroom as content that introduces the chatroom. For example, referring to FIG. 9, the processor 220 may enter an openchat cover screen 900 according to an openchat cover entry request from the user and, here, may display at least one message summary 910 through the openchat cover screen 900. The openchat cover screen 900 may represent a home screen (main screen) on which profile information on an openchat chatroom (e.g., openchat name, profile image, openchat description, number of signed-up members) is displayed. The message summary 910 displayed on the openchat cover screen 900 may include, for example, a most recently generated message summary, a message summary with the largest number of messages subject to summary, and a message summary with the largest number of conversation participants for the messages subject to summary. Depending on example embodiments, not the message summary 910, but rather recommendation content (e.g., content retrieved with a main keyword of the most recently generated message summary) related to the message summary 910 may be displayed on the openchat cover screen 900 as content that introduces the chatroom.

Further, at least some example embodiments may use a message summary generated every cycle based on a chatroom to provide user personalization-based feed. The processor 220 may provide a message summary that matches a tag of interest in which a main keyword is set (or, alternatively, preset) by the user among message summaries generated for each chatroom as the user's personal recommendation feed.

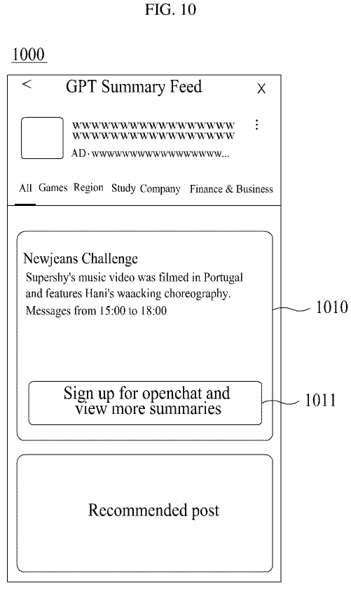

Referring to FIG. 10, the processor 220 may provide a feed providing page 1000 using a message summary to the user as one of openchat-related service menus. Here, the feed providing page 1000 may include a message summary 1010 that matches a tag set (or, alternatively, preset) by the user. The processor 220 may provide the message summary 1010 corresponding to the user's interest as feed. Here, an openchat link 1011 linkable to an openchat chatroom that is a source of the corresponding message summary 1010 may also be provided for each message summary 1010.

As described above, according to example embodiments, it is possible to provide user-customized content through an improved (or, alternatively, an optimal) UI by generating a message summary for each chatroom for a chatroom that meets a condition rather than all chatrooms, and by highlighting and displaying a message summary for a target user among users in the chatroom through a UI different from that of another user. Accordingly, network resources and communication and/or computing resources of a computing device may be effectively used (e.g., less resources may be used) when considering participation in the chatroom. In other words, the message summary associated with a chatroom can be easily obtained without individually entering the chatroom, reviewing the contents therein, and performing resources-consuming compiling of activity based on the results of reviewing the contents of the chatroom.

The apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may continuously store computer-executable programs or may temporarily store the same for execution or download. Also, the media may be various types of recording devices or storage devices in a form in which one or a plurality of hardware components are combined. Without being limited to media directly connected to a computer device, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While this disclosure includes some example embodiments, it will be apparent to one of ordinary skill in the art that various alterations and modifications in form and details may be made in the disclosed example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A message summary providing method executed by a computer device including at least one processor configured to execute computer-readable instructions included in a memory, the message summary providing method comprising:
generating, by the at least one processor, a message summary using at least one message included in a corresponding chatroom for each chatroom; and
displaying, by the at least one processor, the message summary through a different interface depending on a message read status of a user that requests entry into the chatroom.

2. The message summary providing method of claim 1, further comprising:
determining a message summary generation status according to a condition related to a message of the chatroom for each chatroom.

3. The message summary providing method of claim 2, wherein the determining the message summary generation status comprises:
determining the chatroom as a chatroom subject to summary when a number of messages exchanged through the chatroom after a previous message summary is greater than or equal to a threshold.

4. The message summary providing method of claim 2, wherein the determining the message summary generation status comprises:
setting a cycle or a time for determining the condition and the message summary generation status based on traffic analysis results of the chatroom for each chatroom.

5. The message summary providing method of claim 1, wherein the generating the message summary comprises:
selecting messages exchanged through the chatroom after a previous message summary as messages subject to summary.

6. The message summary providing method of claim 1, wherein the generating the message summary comprises:
selecting a message corresponding to a text type among messages exchanged through the chatroom after a previous message summary as a message subject to summary.

7. The message summary providing method of claim 5, wherein the generating the message summary comprises:
modifying an order of the messages subject to summary based on relationships between the messages.

8. The message summary providing method of claim 5, wherein the generating the message summary further comprises:
generating the message summary based on meta information associated with the chatroom with the messages subject to summary, the meta information including at least one of a title, a description, a topic, or a category of the chatroom.

9. The message summary providing method of claim 1, wherein the displaying the message summary comprises:
classifying the user as a target user or a general user based on a condition associated with at least one of a number of unread messages or a last visit time in the chatroom.

10. The message summary providing method of claim 9, wherein the displaying the message summary further comprises:
highlighting and displaying the message summary for the target user through an interface different from that of the general user.

11. The message summary providing method of claim 1, wherein the displaying the message summary comprises:
generating summary content that summarizes at least one message included in the chatroom and a main keyword that represents the summary content.

12. The message summary providing method of claim 1, further comprising:
generating, by the at least one processor, recommendation content related to the message summary for the message summary.

13. The message summary providing method of claim 1, further comprising:
generating, by the at least one processor, at least one of the message summary or recommendation content related to the message summary for the chatroom as content that introduces the chatroom.

14. The message summary providing method of claim 1, wherein the generating the message summary comprises:
generating, by the at least one processor, the message summary such that the message summary matches a tag of interest of the user among message summaries generated based on the chatroom as a personal recommendation feed of the user.

15. A non-transitory computer-readable record medium storing instructions that, when executed by a processor, cause the processor to execute the message summary providing method of claim 1 on the computer device.

16. A computer device comprising:
at least one processor configured to execute computer-readable instructions included in a memory to configure the computer device to,
generate a message summary using at least one message included in a corresponding chatroom for each chatroom; and
display the message summary through a different interface depending on a message read status of a user that requests entry into the chatroom.

17. The computer device of claim 16, wherein the at least one processor is configured to cause the computer device to determine a message summary generation status according to a condition related to a message of the chatroom for each chatroom.

18. The computer device of claim 16, wherein the at least one processor is configured to cause the computer device to,
select messages exchanged through the chatroom after a previous message summary as messages subject to summary,
modify an order of the messages subject to summary based on relationships between the messages, and
generate the message summary using meta information of the chatroom with the messages subject to summary.

19. The computer device of claim 16, wherein the at least one processor is configured to cause the computer device to,
classify the user as a target user or a general user based on a condition for at least one of a number of unread messages and a last visit time in the chatroom, and
highlight and display the message summary for the target user through an interface different from that of the general user.

20. The computer device of claim 16, wherein the at least one processor is configured to cause the computer device to provide at least one of the message summary or recommendation content related to the message summary for the chatroom as content that introduces the chatroom.
